(19) United States
(12) Patent Application Publication
(10) Pub. No.: US 2010/0268395 A1
(43) Pub. Date: Oct. 21, 2010

(54) SYSTEM AND METHOD FOR DETECTING PERFORMANCE

(75) Inventors: Hvas, Sandvad Ingemann, Singapore (SG); Pey Yen Siew, Singapore (SG); Yee Soon Tsan, Singapore (SG)

Correspondence Address: SQUIRE, SANDERS & DEMPSEY L.L.P, PATENT DEPARTMENT, 275 BATTERY STREET, SUITE 2600, SAN FRANCISCO, CA, 94111-3356, US

(73) Assignee: Vestas Wind Systems A/S, Arhus N (DK)

(21) Appl. No.: 12/747,378

(22) PCT Filed: Dec. 11, 2007
(86) PCT No.: PCT/SG07/00427

§ 371 Date: Jun. 10, 2010

(51) Int. Cl. G06F 1/28; G06F 17/18; G08B 21/00

(52) U.S. Cl. 700/289; 702/179; 340/540; 702/182

(57) ABSTRACT

A method for monitoring the operation of a wind turbine generator comprising the steps of sampling a physical parameter related to said apparatus to produce an initial data set, conducting a statistical analysis on said initial data set to establish initial statistical values for said parameter; after a predetermined interval, re-sampling the physical parameter to create a re-sampled data set; conducting statistical analysis on the resampled data set to establish subsequent statistical values; comparing said subsequent statistical values with the initial statistical values and; selecting an action based upon said comparison.

### FIELD OF THE INVENTION

The invention relates to the operation of wind turbine generators (WTG) and in particular to data acquisition and analysis for preventive maintenance and active control.

### BACKGROUND OF THE INVENTION

In the cost analysis of large capital intensive machinery, such as wind turbine generators, after the initial capital expenditure the next most important issue is the economic life of the machine over which the capital expenditure may be amortized. To this end, extending the economic life is a critical determinant in the cost efficiency of the system.

It follows that the scheduling of regular maintenance is a key factor in maintaining the economic life of WTG's. This is intended, firstly, as a means of preventative action to stop or limit deterioration. Further, it is intended to detect any potential problems as early as possible and ameliorate these problems as they arise during subsequent maintenance events.

Balanced against the extension of the economic life of the device is the loss of capacity caused by the downtime of the machine during maintenance, not to mention the cost of the maintenance itself. Whilst frequently scheduled maintenance will have an effect on lengthening the economic life, there is a practical limit to this benefit that will be met through the loss of capacity.

It is, therefore, a risk that too infrequent the maintenance events, the greater the likelihood of a problem going undetected until significant damage has been caused by preventable problems through more frequent maintenance events.

An alternative, or complementary, strategy is the monitoring of parameters of the machine, for instance, turbine temperature, base load, unloaded turbine speed, vibration, speed/torque characteristic or cooling water temperature. This is not an exhaustive list and further parameters may be used to continuously or continually monitor these parameters.

This leads to a further problem through having to monitor several parameters and analyze performance based on the collected data. Monitoring such parameters can yield a significant quantity of data which must be stored and analyzed. As with the scheduling of maintenance events, the frequency of data sampling balanced against the ability to store and analyze large quantities of data is one that meets a practical limitation. Whilst several systems exist which do monitor the performance, the problem of data acquisition storage and analysis of large quantities of data is not easily handled.

### STATEMENT OF INVENTION

In a first aspect, the invention provides a method for monitoring the operation of a wind turbine generator comprising the steps of sampling a physical parameter related to said apparatus to produce an initial data set, conducting a statistical analysis on said initial data set to establish initial statistical values for said parameter; after a predetermined interval, re-sampling the physical parameter to create a re-sampled data set; conducting statistical analysis on the re-sampled data set to establish subsequent statistical values; comparing said subsequent statistical values with the initial statistical values and; selecting an action based upon said comparison.

In a second aspect, the invention provides a system for monitoring the operation of a wind turbine generator comprising; a sensor for sensing a physical parameter related to said apparatus; a controller in communication with said sensor for receiving data from the sensor, said controller further arranged to conduct a statistical analysis and output initial statistical values to a database; said database arranged to compare statistical values received from said controller and arranged to initiate an action should subsequent statistical values fall outside acceptable operating limits of the initial statistical values.

Thus the invention limits the need for unscheduled maintenance events by maintaining a variation in monitoring process. It further avoids the collection of large volumes of data by collecting discreet data sets, then conducting statistical analyses on these data sets and comparing them to statistical analyses taken from an initial data sampling.

In a preferred embodiment the physical parameters may include any one or a combination of cooling water temperature, turbine speed, speed/torque characteristic or vibration.

In a further preferred embodiment the statistical values may include mean, any one or a combination of standard deviation, normality, variance, regression, median.

In a further preferred embodiment the predetermined intervals may be any one of one minute, ten minutes, one hour and twelve hours.

In a preferred embodiment, the invention may be applied on a modular level. By examining the data distribution from a large number of components and adaptive control, detection of early failure symptoms in the whole system may permit taking necessary procedures to prevent the failure of the whole system.

### BRIEF DESCRIPTION OF DRAWINGS

It will be convenient to further describe the present invention with respect to the accompanying drawings that illustrate possible arrangements of the invention. Other arrangements of the invention are possible and consequently, the particularity of the accompanying drawing is not to be understood as superseding the generality of the preceding description of the invention.

FIGS. 1A to 1E are graphical representations of collected data according to an embodiment of the present invention;

FIG. 2 is a flow chart of a process according to a further embodiment of the present invention;

FIG. 3 is a schematic view of the process according to a further embodiment of the present invention.

### DESCRIPTION OF PREFERRED EMBODIMENT

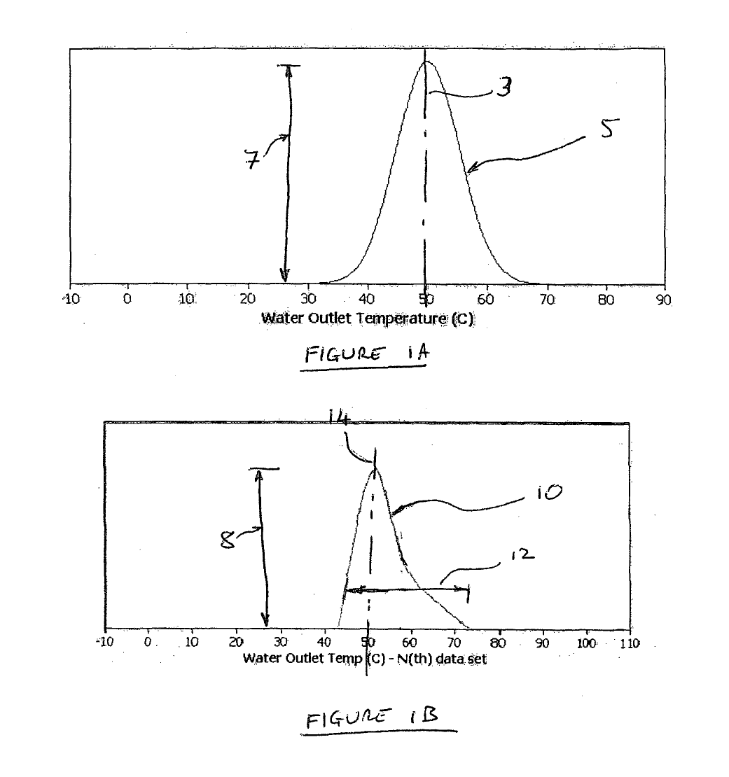

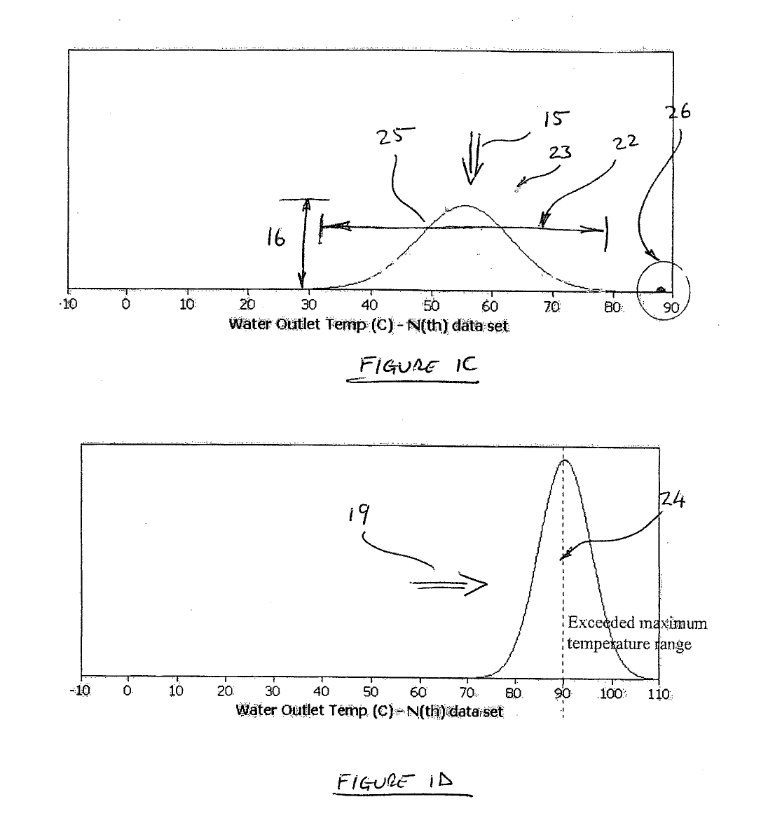

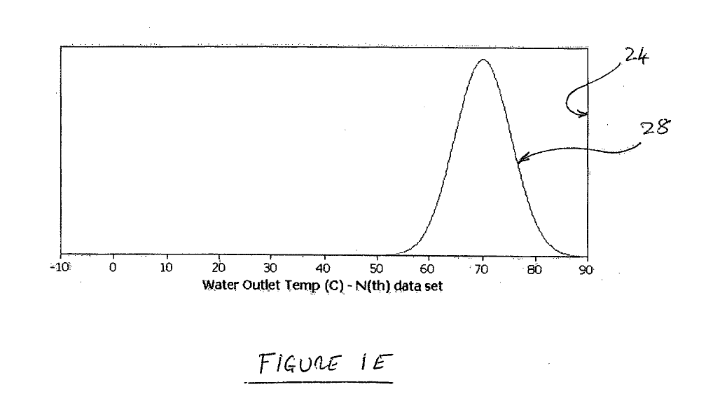

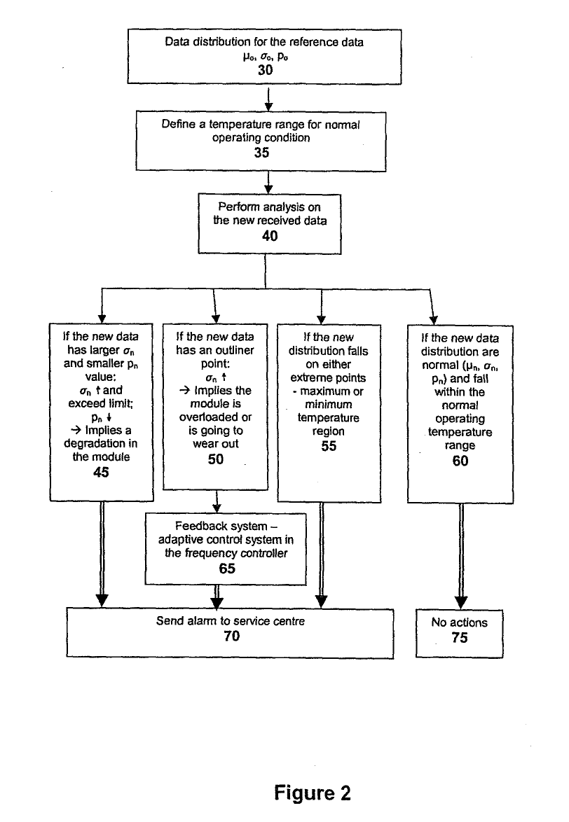

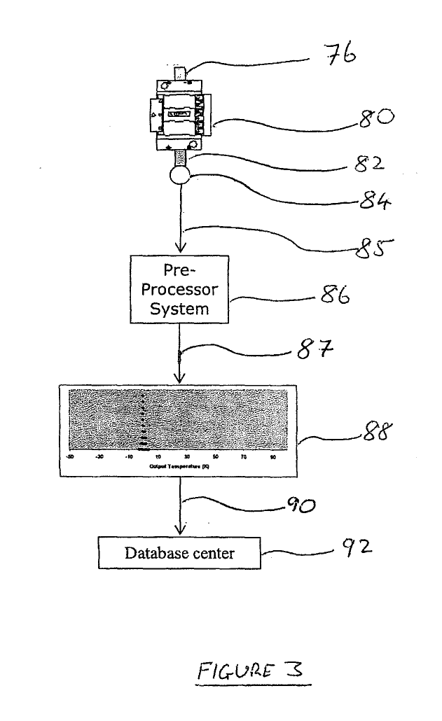

FIGS. 1A to 1E show graphical representations of the collected data according to an embodiment of the present invention. These figures are further to be read together with the flow chart of FIG. 2 detailing actions to be taken subject to the results of the method according to the present invention. FIG. 1A shows the initial data 5 taken at an appropriate early stage in the life of the WTG. In practice, it may be the first data set taken after full commissioning of the WTG to ensure any settling effects of the machine are not skewing the initial data upon which subsequent data sets will be compared. Following a statistical analysis of the initial data set, the mean, standard deviation and normality are calculated for later comparison with the statistical values of subsequent data sets.

FIG. 1B shows a graphical representation of a subsequent data set 10 for comparison with the initial data set. Whilst the raw data for any specific data set may be continuous, between sampling of data sets there is an interval whereby data is not taken, and so limiting the size of the data set involved . . . . Further, statistical values are taken from each data set and are used for comparison rather than actual data which will require further storage capacity. Thus, a historical record may be maintained of the performance of the WTG based on the recorded statistical value rather than actual data sets.

In the example provided in FIG. 1B, the subsequent data set 10 is skewed, suggesting a reduction in normality. Further the spread of data 12 as compared to that of the initial data set indicates an increased standard deviation and, therefore, an overloaded or overworked power module leading to degradation. This corresponds to a drop in the peak 8 based upon the variation in height 7 of the initial data to the height of the subsequent data.

FIG. 1C shows a different result for s subsequent data set, whereby an outliner point 26 is recorded, leading to an increase in the standard deviation 22, with the peak 16 shifted downwards 15.

FIG. 1D indicates a subsequent data set whereby the standard deviation and normality are within acceptable limits, but the mean temperature has shifted upwards 19 to the maximum limit 24 of temperature range.

By contrast to the representation in FIG. 1D, FIG. 1E shows a subsequent data set whereby the temperature mean has shifted upwards, but still lies within the acceptable temperature range. Accordingly, no further action is required

An ideal data distribution, as shown in FIG. 1A may be comparatively narrow, which will correspond to a small σ on the distribution. If, after sometime in operation, the set of distribution has wider spread than the reference set of data distribution (i.e. σ is larger value) and exceeded defined limits; or if the new dataset are skewed and so no longer represent a normal distribution (i.e. ρ value is small), investigations are carried out to find out the causes. These changes (large σ and small ρ) indicate reduced performance (i.e. degradation) which again will cause unscheduled maintenance.

In the example given, the machine is a wind turbine generator with the sampled physical parameter being the cooling water exiting from one or more power modules associated with the wind turbine generator. FIG. 2 shows a process by which the comparison can be made. The process commences with the collection of reference data 30 from which initial statistical values mean (μₒ), standard deviation (σₒ) and normality (ρₒ) temperature sensors are recorded. Further the user can defines a temperature range for which normal operation of the power module may be expected over the life of the wind turbine generator.

Subsequent data acquisition after a predetermined interval is taken and an analysis performed on this data so as to produce a mean (μₙ) standard deviation (σₙ) and normality (ρₙ) for the newly collected data. These statistical values are then compared to the initial statistical values taken resulting in one of four permutations:
i) If the standard deviation increases, with a reduction in normality through a skewed distribution this suggests a degradation of the power module as shown in FIG. 1B;
ii) If the standard deviation increases with no marked change in mean or normality 50, this suggests data points well outside the normal range and so, implying the module is overloaded and, therefore, susceptible to deterioration. This can then trigger a feed back system 65 whereby the power module may come under adaptive control to more evenly spread load to either accommodate a disproportionate load to the power modules within the wind turbine generator or alternatively, to relieve some or all of the load from the power module experiencing the overload. This arrangement is shown in FIG. 1C.
iii) We also need to define a temperature range (maximum temperature—indicates open circuit; and minimum temperature—indicates short circuit) for the distribution. A distribution which falls at either extreme points are not reliable hence, has to be filtered out. If the shift in mean places the distribution at the maxima or minima of the temperature range 55, as shown in FIG. 1D, this suggests the power module may be suffering a variety of problems requiring inspection;
iv) If, however, the mean, standard deviation and normality fall within the accepted range as determined in 35, then it may be presumed the power module is operating normally, as shown in FIG. 1E, even though the subsequent mean temperature may have shifted from the initial mean temperature.

In the case of (i), (ii) and (iii) some form of corrective action is required and so an unscheduled maintenance event may result. In any event, a warning or alarm is sent by the system to a service center for review. In the case of (ii), an outliner data point in the distribution can be used as the feedback to the controller. This outliner data point increases the σ of the whole distribution. It might indicate the particular module is running at overloaded condition or the module is going to wear out.

Hence, an adaptive control system in the frequency converter controller can detect this signal and share the heavy load on that failing module with the other modules. This will increase the overall degradation tolerance of the module.

However, in the case of (iv), normal operation suggests that no variation to the scheduling of the maintenance events is required until further data collection is scheduled. No alarm should be alerted if the distribution had been shifted (different σ, μ and p values) forward or backward with respect to the reference data but within an acceptable limits and is a normal distribution.

It can, therefore, be seen that by adopting the present invention, maintenance events can be periodically scheduled due to the regular monitoring of specified parameters. Further because of the discreet data sets taken and comparison made based on statistical values only, the volume of data collected is considerably reduced without compromising the regularity of said monitoring.

FIG. 3 shows a schematic view of the system according to the present invention and in particular, the embodiment as discussed. Here, a power module 80 receives water 76 for cooling set 80 which subsequently exits 82 the power module. Positioned at the outlet is a temperature sensor 84 from which is collected a temperature data set, for instance, every ten minutes which then undergoes a pre-processing to identify the data set 88. The data set undergoes a statistical analysis 90 to obtain the standard deviation mean and normality which is subsequently stored at a data base 92 whereupon it can be compared with the initialized data and kept as a historical record of the performance of the power module 80.

The system is able to perform pre-processing online supervision of a converter and other parts in a WTG. The result can be used for predictive maintenance and also in active control to prevent unscheduled services.

The invention, therefore, provides significant advantages:

(i) Economy—This is an optimized way to manage the data. Temperature sensors may be eliminated/reduced as only water outlet temperatures are needed in the analysis.
(ii) Functional—Production of the WTG machine may be optimized as any abnormal changes in the machine are detected hence perform maintenance/replacement on the modular converter before it fails. This may reduce unscheduled breakdown of the machine.
(iii) Service—The invention provides the service center with a good insight into the conditions of the converter system and helps them to plan for the next service schedule so as to reduce the risk for breakdown. They can also make a decision on what are the components and special tools to bring during scheduled maintenance events.
(iv) Quality/Life time—The invention may improve the quality of a converter system as unscheduled maintenance had been reduced. The life time of the converter system may be extended as the module is replaced before it fails which might induce other failure in the converter.

1. A method for monitoring the operation of a wind turbine generator comprising the steps of:
sampling a physical parameter related to said apparatus to produce an initial data set, conducting a statistical analysis on said initial data set to establish initial statistical values for said parameter;
after a predetermined interval, resampling the physical parameter to create a resampled data set;
conducting statistical analysis on the resampled data set to establish subsequent statistical values;
comparing said subsequent statistical values with the initial statistical values and;
selecting an action based upon said comparison.

2. The method according to claim 1, further comprising the step, preceding the sampling step, of defining an acceptable operating range for the initial statistical values.

3. The method according to claim 1 wherein said statistical values include any one or a combination of mean, median, variance, standard deviation, normality, regression.

4. The method according to claim 1, wherein said physical parameter includes any one or a combination of cooling water temperature, turbine temperature, base load, unloaded turbine speed, vibration and speed/torque characteristic.

5. The method according to claim 1, wherein data sampled during said sampling and resampling steps is limited by either a time period or a discreet number of data points.

6. The method according to claim 5 wherein the time period for the sampling and resampling steps is in the range 1 minute to 1 hour.

7. The method according to claim 2 wherein if the subsequent standard deviation is greater than acceptable operating range for the initial standard deviation then the action selected includes the step of sending an alarm.

8. The method according to claim 2 wherein if the subsequent standard deviation is greater than the acceptable operating range for the initial standard deviation and the subsequent normality is within the acceptable operating range for the initial normality, then the action selected includes the step of introducing adaptive control of said wind turbine generator.

9. The method according to claim 8 wherein the action selected further includes the step of sending an alarm.

10. The method according to claim 8 wherein the step of introducing adaptive control includes the step of distributing load to subsequent power modules within the wind turbine generator.

11. A system for monitoring the operation of a wind turbine generator comprising;
a sensor for sensing a physical parameter related to said apparatus;
a controller in communication with said sensor for receiving data from the sensor, said controller further arranged to conduct a statistical analysis and output initial statistical values to a database;
said database arranged to compare statistical values received from said controller and arranged to initiate an action should subsequent statistical values fall outside acceptable operating limits of the initial statistical values.

12. The system according to claim 11 wherein the sensor is a temperature sensor for measuring cooling water temperature from said wind turbine generator.

13. The system according to claim 11 wherein the wind turbine generator includes at least one power module with the temperature sensor located at a water outlet of the at least one power module.

14. The system according to claim 13 wherein said wind turbine generator has a plurality of power modules with the controller arranged to receive data and conduct the statistical analysis of said data for each of said plurality of power modules.

15. The system according to claim 14 wherein on receipt of a statistical value from one power module exceeding acceptable operating limits, the system is adapted to selectively distribute load from the one power module to the remaining power modules
